(19) United States
(12) Patent Application Publication
(10) Pub. No.: US 2007/0229402 A1
(43) Pub. Date: Oct. 4, 2007

(54) Filter and display apparatus having the same

(76) Inventors: Ji-Suk Kim, Suwon-si (KR); Cha-Won Hwang, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/727,477

(22) Filed: Mar. 27, 2007

(30) Foreign Application Priority Data
Mar. 28, 2006 (KR) 10-2006-0028116

(51) Int. Cl. G09G 3/28

(52) U.S. Cl. 345/60

(57) ABSTRACT

A display apparatus includes a display and a display filter, wherein the display filter includes a base film and a plurality of beads, wherein each bead includes a light absorbing element and a transparent layer.

### CROSS-REFERENCE TO RELATED APPLICATION

This application is related to co-pending U.S. patent application Ser. No. ______, entitled “FILTER AND DISPLAY APPARATUS HAVING THE SAME,” which was filed on Mar. 27, 2007.

### BACKGROUND OF THE INVENTION

1. Field of the Invention

Embodiments of the present invention relate to a filter and a display apparatus having the filter. More particularly, embodiments of the present invention relate to a filter that may increase bright room contrast by increasing transmittance of light emitted from inside the display apparatus and blocking light incident from outside the display apparatus, and a display apparatus having the filter.

2. Description of the Related Art

A display apparatus may include a filter in order to effect changes in various display characteristics, such as reducing reflections, etc., and to protect the display against damage. However, such a display apparatus may exhibit double reflections due to refraction caused by a material difference between a front of the display and the filter. Also, a tempered glass filter may be used to protect the display apparatus, but such a filter may need to have a thickness of 3 mm or more to resist external impact, which increases the weight and cost of the display apparatus. Furthermore, a tempered glass filter may have a complicated structure including various filters having various functions. Therefore, the process of manufacturing the tempered glass filter may be complicated and costly.

### SUMMARY OF THE INVENTION

The present invention is therefore directed to a filter and a display apparatus having the same, which substantially overcome one or more of the problems due to the limitations and disadvantages of the related art.

It is therefore a feature of an embodiment of the present invention to provide a display filter having a plurality of beads including a light absorbing element and a transparent layer, the beads adapted to diffuse light emitted by the display while diminishing reflections from external light sources.

It is therefore another feature of an embodiment of the present invention to provide a filter that may be directly attached to a display.

At least one of the above and other features and advantages of the present invention may be realized by providing a display apparatus, including a display and a display filter, wherein the display filter includes a base film and a plurality of beads, wherein each bead includes a light absorbing element and a transparent layer.

The display may include pixels of a predetermined size, and light absorbing elements of adjacent beads may be separated by a distance corresponding to the predetermined size. The display may include pixels of a predetermined size, and a size of the bead may correspond to the predetermined size. The display may include a plasma display panel having discharge cells of a predetermined width, and a width of the bead may correspond to the predetermined width. The display filter may be directly attached to the display.

At least one of the above and other features and advantages of the present invention may also be realized by providing a display filter, including a base film and a plurality of beads, wherein each bead includes a light absorbing element and a transparent layer.

The filter may further include a coating layer on the base film, the coating layer fixing the plurality of beads to the base film. The coating layer and the transparent layer may have substantially the same refractive index. The coating layer may include a dye or a pigment that modifies at least one of a color and a transmittance of visible light.

The light absorbing element may be a black bead. The beads may abut one another. The light absorbing element may be substantially surrounded by the transparent layer.

The volume of the light absorbing element may be about 3% to about 80% of the volume of the bead. The diameter of the bead may be about 3 μm to about 30 μm. The bead may be substantially spherical. The bead may have a circular or oval cross-section.

The filter may further include a reflection prevention layer. The filter may further include an electromagnetic shielding layer. The filter may further include an adhesive layer on the electromagnetic shielding layer, and a reflection prevention layer on the adhesive layer. The filter may further include a color correction layer.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a cross-sectional view of a filter according to an embodiment of the present invention;

FIG. 2 illustrates a cross-sectional view of a filter according to another embodiment of the present invention;

FIG. 3 illustrates an exploded perspective view of a display apparatus having a filter according to an embodiment of the present invention; and

FIG. 4 illustrates a cross-sectional view taken along a line IV-IV of FIG. 3.

### DETAILED DESCRIPTION OF THE INVENTION

Korean Patent Application No. 10-2006-0028116, filed on Mar. 28, 2006, in the Korean Intellectual Property Office, and entitled: “Filter and Plasma Display Apparatus Having the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

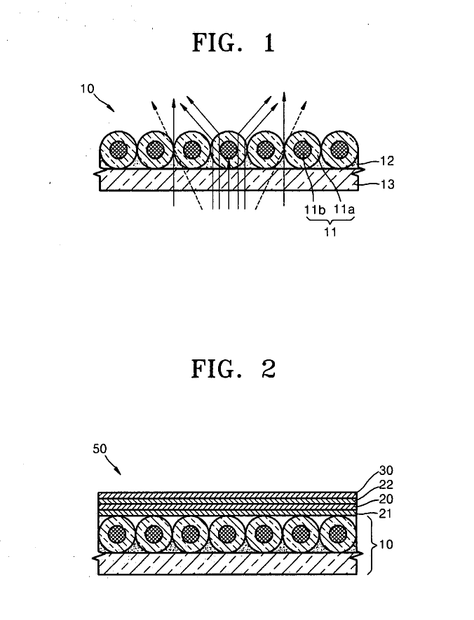

FIG. 1 illustrates a cross-sectional view of a filter 10 according to an embodiment of the present invention. Referring to FIG. 1, the filter 10 may include a plurality of beads 11 and a base film 13. The filter 10 may further include a coating layer 12.

As indicated by the arrows in FIG. 1, the filter 10 may partly block, partly transmit, and partly diffuse visible light incident from the rear side 10b, or display side, of the filter 10. Also, visible light incident from the front of the filter 10 may be partly blocked, partly transmitted, and partly diffused. In FIG. 1, dotted arrows indicate light incident on the filter 10 at an angle, such as diffused light, and solid arrows indicate light incident on the filter 10 normal to the major plane of the filter 10.

A display apparatus having the filter 10 may exhibit enhanced bright room contrast. In an implementation, the filter 10 may be a contrast enhancing filter (CEF). The filter 10 may be implemented as a directly attached filter, which is directly attached to the display.

The beads 11 may each have a generally spherical shape which may be circular or oval in cross-section. The beads 11 may each include a transparent layer 11a surrounding a light absorbing element 11b. The transparent layer 11a may completely surround the light absorbing element 11b. The light absorbing element 11b may itself be a bead having a shape similar to that of the overall bead 11, but smaller. The light absorbing element 11b may have a high absorption rate of visible light, and the transparent layer 11a may have a high transmittance of visible light. The light absorbing element 11b may be, e.g., a black bead.

The transparent layer 11a may be made of, e.g., an acryl polymer or a urethane polymer, and the light absorbing element 11b may be made of carbon black. If the filter 10 according to an embodiment of the present invention is applied to a plasma display panel, and a discharge cell of the plasma display panel has a width of about 100 μm to about 200 μm, the light absorbing element 11b may have a diameter of about 3 μm to about 30 μm and may have a volume of about 3% to about 80% of the volume of the bead 11 including the volume of the transparent layer 11a. A diameter of about 3 μm to about 30 μm and a volume of about 3% to about 80% of the volume of the bead 11 may help maximize a bright room contrast diffusion effect by blocking, transmitting, and diffusing light. In an implementation, the display may have pixels of a predetermined size, and the diameter and/or volume of the light absorbing elements 11b may be correlated to the size of the pixels. For example, the diameter and/or volume of the light absorbing elements 11b may correspond to a size of discharge cells in a plasma display panel of a plasma display apparatus.

The filter 10 may include a plurality of beads 11 attached to the base film 13. The beads 11 may form a single layer on the base film 13, and may be substantially uniformly distributed on the base film 13. The beads 11 may abut one another, as illustrated in FIG. 1, or may be spaced apart from one another (not shown).

The coating layer 12 may attach the beads 11 to the base film 13. The coating layer 12 may be formed of a material that transmits light. In an implementation, the coating layer 12 may be formed of an acryl resin in a molten state, so that after the base film 13 and the beads 11 are fixed, the acryl resin can be solidified.

The coating layer 12 and the transparent layer 11a of the bead 11 may be formed of materials having substantially the same refractive index or having a difference in refractive indexes of less than about 0.5. This may help reduce refraction of visible light at the interface of the coating layer 12 and the transparent layer 11a. The coating layer 12 may include a dye or a pigment to control the color or transmittance of visible light emitted from the display through the coating layer 12.

As illustrated in FIG. 1, the coating layer 12 may have a thickness of approximately one-half the diameter of the beads 11 and may cover approximately one-half of the beads 11. In other implementations (not shown), the coating layer 12 may have a thickness substantially equal to the diameter of the beads 11, greater than the diameter of the beads 11 so as to completely cover the beads 11, etc.

The base film 13 may be formed of a material that transmits visible light. The base film 13 may be adapted so that the filter 10 can be directly attached to a front surface of the display. The base film 13 may be, e.g., a transparent material that allows the filter 10 to be attached to glass or plastic. The base film 13 may be formed of a flexible material, which may allow for convenient transporting and attaching to the display.

Various materials, or combinations thereof, may be employed for the base film 13. For example, the base film 13 may be formed of polyethersulphone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose triacetate (TAC), cellulose acetate propionate (CAP), etc. PC, PET, TAC, and PEN may be particularly suitable for the base film 13.

The base film 13 may be colored to control the transmittance of visible light of the whole filter 10. For example, the transmittance of visible light may be reduced by providing the base film 13 with a dark color, the whole base film 13 may be colored to give a pleasant appearance to the user, or it may be colored to increase the chroma of the display apparatus. The color of the base film 13 may be patterned to correspond to pixels of the display. In an implementation, the color of the base film 13 may be patterned to correspond to subpixels of a plasma display panel. It will be appreciated that the base film 13 may be colored in various ways for a variety of color correction purposes.

The base film 13 may have a flat, substantially planar shape, and may have a thickness of about 50 μm to about 500 μm. If the base film 13 is too thin, it may not be effective to prevent the scattering of glass fragments if the display apparatus is damaged by an impact. However, if the thickness of the base film 13 is unduly increased, the efficiency of a laminating process may be reduced. In an implementation, the base film 13 may have a thickness of about 80 μm to about 400 m.

FIG. 2 illustrates a cross-sectional view of a filter 50 according to another embodiment of the present invention. Referring to FIG. 2, the filter 50 may include the filter 10 described above, as well as one or more additional layers such as an electromagnetic wave shielding layer 20, a film layer 21, an adhesive layer 22, and/or a reflection prevention layer 30.

The electromagnetic wave shielding layer 20 and the reflection prevention layer 30 may be attached to the filter 10 on the back side of the base film 13 (not shown) or, as depicted in FIG. 2, may be attached to the side of the filter 10 where the beads 11 are located. The electromagnetic wave shielding layer 20 may block electromagnetic waves. Such waves may be generated by the display apparatus, e.g., where the display apparatus includes a plasma display panel. Blocking such waves may prevent unwanted interference, and may reduce the possibility of exposing a person adjacent to the display to harmful waves. A metal layer and/or the metal oxide layer in the electromagnetic wave shielding layer 20 may block near infrared light as well as electromagnetic waves. Accordingly, malfunction of peripheral electronic devices, such as those employing infrared light-based remote controls, due to the near infrared light may be reduced.

The electromagnetic wave shielding layer 20 may be adapted to a variety of suitable shapes and forms and may be implemented as, e.g., a mesh of conductive metal. In an implementation, the electromagnetic wave shielding layer 20 may be formed by stacking a plurality of metal layers and/or metal oxide layers, e.g., in a multilayer structure of five to eleven layers. In particular, if metal oxide layers and metal layers are stacked together, the metal oxide layers may reduce or prevent degradation of the metal layers. Also, if the electromagnetic wave shielding layer 20 is formed by stacking multiple layers, the surface resistance value of the electromagnetic wave shielding layer 20 may be corrected, and this may also allow for controlling the transmittance of visible light.

The metal layer may be formed of, e.g., palladium, copper, platinum, rhodium, aluminum, iron, cobalt, nickel, zinc, ruthenium, tin, tungsten, iridium, lead, silver, a composite of these metals, etc. The metal oxide layer may be formed of tin oxide, indium oxide, antimony oxide, zinc oxide, zirconium oxide, titanium oxide, magnesium oxide, silicon oxide, aluminum oxide, a metal alkoxide, indium tin oxide (ITO), antimony tin oxide (ATO), etc.

The electromagnetic wave shielding layer 20 may be formed by suitable processes such as sputtering, vacuum evaporation, ion plating, chemical vapor deposition (CVD), plasma vapor deposition (PVD), etc. The electromagnetic wave shielding layer 20 may be formed after the film layer 21 is formed on the front surface of the filter 10, i.e., the film layer 21 may be interposed between the electromagnetic wave shielding layer 20 and the filter 10.

The reflection prevention layer 30 may serve to diffuse external incident light at the surface of the filter 50, i.e., light impinging on the filter 50 from outside the display apparatus. Thus, the reflection prevention layer 30 may reduce or prevent the reflection of the peripheral environment from the surface of the filter 50.

The filter 50 may be directly attached to a front surface of a display, and thus the reflection prevention layer 30 may be combined with the filter 50. In contrast, if a reflection prevention layer were to be combined with a conventional tempered glass filter, image clarity could be reduced due to an interface between the front of the display and the tempered glass filter. Thus, it may not be desirable to combine a reflection prevention layer with a conventional tempered glass filter. However, the filter 50 according to this embodiment of the present invention may not exhibit such a reduction in image clarity because the filter 50 may be directly attached to the front surface of a display, e.g., attached to a front surface of a plasma display panel.

The filter 50 may further include a hard coating material (not shown) inside the reflection prevention layer 30. Such a hard coating material may help reduce the occurrence of scratches. That is, scratches on the filter 50 caused by external forces may be reduced or prevented by the hard coating material in the reflection prevention layer 30. The hard coating material may be coated inside the reflection prevention layer 30. An additional hard coating layer (not shown) may also be formed on the reflection prevention layer 30.

The hard coating material may include a polymer as a binder, e.g., an acryl polymer, a urethane polymer, an epoxy polymer, a siloxane polymer, an ultraviolet hardening resin such as oligomer, etc. To increase hardness, a silica group filler may be included in the hard coating material.

In an implementation, the reflection prevention layer 30 may have a thickness of about 2 μm to about 7 μm and a pencil hardness of about 2H to about 3H.

The adhesive layer 22 may be disposed between the electromagnetic wave shielding layer 20 and the reflection prevention layer 30. The adhesive layer 22 may provide an adhesive force between the electromagnetic wave shielding layer 20 and the reflection prevention layer 30. An adhesive layer may also be formed on the lower surface of the filter 10 (not shown) to provide adhesion between the filter 10 and a front surface of the display. To reduce a double image phenomenon, the adhesive layer 22 may have a predetermined refractive index difference with respect to the display. In an implementation, the difference in refractive indices may be less than or equal to about 1%.

The adhesive layer 22 may include, e.g., a thermoplastic UV hardening resin such as an acrylate resin, a pressure sensitive adhesive (PSA), etc. The adhesive layer 22 may be formed by suitable processes such as dip coating, air knife coating, roller coating, wire bar coating, gravure coating, etc.

The adhesive layer 22 may include a compound that absorbs near infrared light. The compound may be, e.g., a resin that includes copper atoms, a resin that includes a copper compound or a phosphorus compound, a resin that includes a copper compound or a thio urea derivative, a resin that includes a tungsten compound, a cyanine compound, etc.

In an implementation, the adhesive layer 22 may further include a dye or a pigment to provide color correction by blocking light commonly referred to as “neon glow.” The dye or pigment may selectively absorb light in the visible region, which is generally considered to be in the 380 nm to 760 nm range or 400 run to 700 nm range. For example, the dye or pigment may be employed when the filter 50 is to be combined with a plasma display panel. When discharge occurs in a plasma display panel, undesirable visible light having a wavelength of approximately 585 nm may be generated by plasma discharge gas. To absorb this light, a pigment of cyanine, squaryl, azomethine, xanthine, oxonol, and/or azo group compounds may be used. The pigment compound may be dispersed in a fine grain state throughout the adhesive layer 22.

In other implementations (not shown), the filter 50 may optionally include a near infrared light shielding layer and/or a color correction layer. Near infrared light may be blocked by the electromagnetic wave shielding layer 20 and/or the adhesive layer 22, and if necessary, the blocking of near infrared light can be increased by adding an additional layer. The color correction layer may be used when the chroma of light generated by the display to which the filter 50 is applied is low, or if corrections to the color temperature are desired.

In an implementation, the filter 50 having the above structure may have a light transmittance of about 30% or more and a haze of less than about 5%.

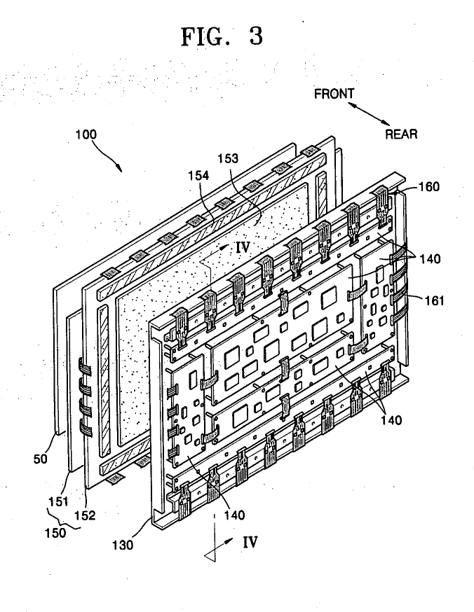

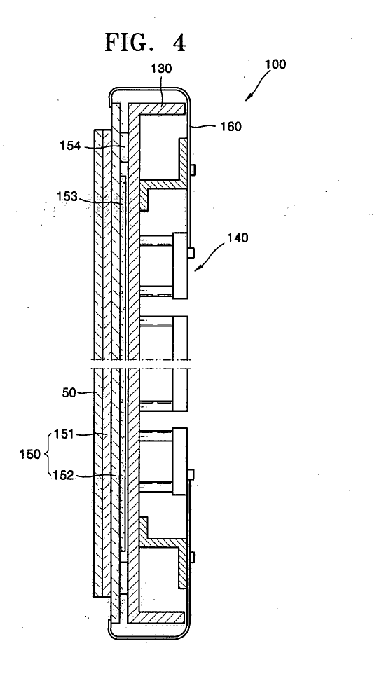

FIG. 3 illustrates an exploded perspective view of a display apparatus 100 having a filter 50 according to an embodiment of the present invention, and FIG. 4 illustrates a cross-sectional view taken along a line IV-IV of FIG. 3. Referring to FIGS. 3 and 4, the display apparatus 100 may include a display panel 150, a chassis 130, and a circuit unit 140. The display panel 150 may include a front panel 151 and a rear panel 152 coupled to each other. The display panel 150 may be, e.g., a plasma display panel. A filter 50 according to an embodiment of the present invention may be attached to the front surface of the display panel 150, e.g., by an adhesive layer (not shown). The filter 50 may be implemented as a directly attached filter.

An adhesive element 154, e.g., double-sided tape, may couple the display panel 150 to the chassis 130. A thermal conduction member 153 may be located between the chassis 130 and the display panel 150, in order to dissipate heat generated by the display panel 150 by conducting the heat to the chassis 130.

The filter 50 may block electromagnetic waves generated by the display panel 150 and may reduce glare. Also, infrared light or neon glow may be blocked by the filter 50. Furthermore, the filter 50 may be substantially directly attached to the front surface of the display panel 150, which may reduce or eliminate a double image. Also, the filter 50 may have a lower weight and/or lower cost than a conventional tempered glass filter.

The chassis 130 may be disposed to the rear of the display panel 150 and may structurally support the display panel 150. The chassis 130 may be formed of a metal having high strength, e.g., aluminum or iron, or of plastic.

The thermal conduction member 153 may be disposed between the display panel 150 and the chassis 130. A plurality of adhesive elements 154 may be provided on the rear panel 152 along the edges of the thermal conduction member 153.

The circuit unit 140 may be located on the rear of the chassis 130. The circuit unit 140 may include circuits that drive the display panel 150. The circuit unit 140 may transmit electrical signals to the display panel 150 via signal transmitting elements 160, 161. The signal transmitting elements may be, e.g., a flexible printed cable, a tape carrier package, a chip on film, etc.

Although this description refers to the filter 50 of FIG. 2, it will be appreciated that embodiments of the present invention are not limited thereto. For example, the display apparatus 100 may simply use the filter 10 illustrated FIG. 1. Further, it will be appreciated that the filters 10, 50 may be various shapes and/or sizes. Additionally, a filter according to an embodiment of the present invention may be used for various display apparatuses including, but not limited to, a plasma display apparatus.

A filter according to an embodiment of the present invention and a display apparatus having the filter may reduce a double image phenomenon, since the filter may be directly attached to the front surface of the display. Also, the filter may have a relatively thin base film and, accordingly, may have a low weight and good light transmittance.

A plurality of beads, which may each include a light absorbing element such as a black bead, may be distributed throughout the filter. Therefore, display brightness may be significantly enhanced by diffusing internal light, and reflection of external light may be significantly decreased, thereby enhancing bright room contrast. Also design of the filter may enable a simple and inexpensive manufacturing process to be used therefor.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display apparatus, comprising:
a display; and
a display filter, wherein the display filter includes:
a base film; and
a plurality of beads, wherein each bead includes a light absorbing element and a transparent layer.

2. The display apparatus as claimed in claim 1, wherein the display includes pixels of a predetermined size, and
light absorbing elements of adjacent beads are separated by a distance corresponding to the predetermined size.

3. The display apparatus as claimed in claim 1, wherein the display includes pixels of a predetermined size, and
a size of the bead corresponds to the predetermined size.

4. The display apparatus as claimed in claim 1, wherein the display includes a plasma display panel having discharge cells of a predetermined width, and
a width of the bead corresponds to the predetermined width.

5. The display apparatus as claimed in claim 1, wherein the display filter is directly attached to the display.

6. A display filter, comprising:
a base film; and
a plurality of beads, wherein each bead includes a light absorbing element and a transparent layer.

7. The filter as claimed in claim 6, further comprising a coating layer on the base film, the coating layer fixing the plurality of beads to the base film.

8. The filter as claimed in claim 7, wherein the coating layer and the transparent layer have substantially the same refractive index.

9. The filter as claimed in claim 7, wherein the coating layer includes a dye or a pigment that modifies at least one of a color and a transmittance of visible light.

10. The filter as claimed in claim 6, wherein the light absorbing element is a black bead.

11. The filter as claimed in claim 6, wherein the beads abut one another.

12. The filter as claimed in claim 6, wherein the light absorbing element is substantially surrounded by the transparent layer.

13. The filter as claimed in claim 6, wherein the volume of the light absorbing element is about 3% to about 80% of the volume of the bead.

14. The filter as claimed in claim 6, wherein the diameter of the bead is about 3 μm to about 30 μm.

15. The filter as claimed in claim 6, wherein the bead is substantially spherical.

16. The filter as claimed in claim 6, wherein the bead has a circular or oval cross-section.

17. The filter as claimed in claim 6, further comprising a reflection prevention layer.

18. The filter as claimed in claim 6, further comprising an electromagnetic shielding layer.

19. The filter as claimed in claim 18, further comprising:
an adhesive layer on the electromagnetic shielding layer; and
a reflection prevention layer on the adhesive layer.

20. The filter as claimed in claim 6, further comprising a color correction layer.
